(19) United States
(12) Patent Application Publication
(10) Pub. No.: US 2003/0183002 A1
(43) Pub. Date: Oct. 2, 2003

(54) Fluid level indicator and container

(75) Inventors: Frank Burger, Duren (DE); Norbert Ludwig, Bruggen (DE)

Correspondence Address: GRIFFIN & SZIPL, PC, SUITE PH-1, 2300 NINTH STREET, SOUTH, ARLINGTON, VA, 22204, US

(73) Assignee: PIERBURG GMBH, Neuss (DE)

(21) Appl. No.: 10/396,374

(22) Filed: Mar. 26, 2003

(30) Foreign Application Priority Data
Mar. 27, 2002 (DE) 102 13 694.7

(51) Int. Cl. G01F 23/60

(52) U.S. Cl. 73/313; 340/623

(57) ABSTRACT

A fluid level indicator for a fluid container of a motor vehicle, including a housing having at least one opening through which a fluid may flow; a float disposed to move in the housing; and a first magnet integrated with the float; wherein the first magnet is functionally connected to a first non-contact sensor integrated into the housing; and wherein the float carries out a translational motion relative to the housing when fluid flows into or out of the at least one opening.

### FIELD OF THE INVENTION

The invention relates to a level indicator and an accompanying fluid container, particularly as used in motor vehicles, with a housing fastened to the upper side of the fluid container, comprising at least one opening, having a float and a magnet functionally-connected to a programmable non-contact sensor that is also integrated in the housing.

BACKGROUND OF THE INVENTION

A, level indicator is disclosed in DE 4438322C2, that has a float, which is operably connected by means of a float lever with a sliding potentiometer and adjusts the sliding potentiometer depending on the fill lever of the fluid container and uses the resulting electrical signal for fluid level indication. Such level indicators have the particular disadvantage that the potentiometer is subject to mechanical wear.

For this reason, in recent years non-contact sensors for fluid level indication have been increasingly put into use.

One such fluid level indicating assembly is, for example, described in German Laid-Open Patent application DE 19944330 A1. The level indicating assembly for a fluid container comprises a lever arm on whose end a float is arranged and on whose other end a carrier portion is journaled. The level arm is connected to a magnet device that moves relative to a magnet sensor with change in the fluid level of the container, wherein the magnet sensor is disposed inside a level indicator sensor housing. By means of the relative movement between the magnet device and the fixed magnet sensor, the impinging magnetic field is changed so that the magnet sensor can send an output signal that corresponds to the fluid level in the fluid container.

A further example of a fluid level indicator device with non-contact sensor is disclosed in German Laid Open Patent Application DE 19925185 A1. This level indicator device comprises a float rotatingly journaled on an axle, as well as a permanent magnet fastened to the axle, wherein the magnetic field of the permanent magnet changes with the fluid level due to rotation of the axle D. This communicates with a non-contact sensor fastened to a tube directly above, wherein the sensor generates an output signal corresponding to the changing field strength, and wherein the signal corresponds, with corresponding programming of the sensor, to the level in the fluid container.

A further example for measuring fluids in a fluid container is disclosed in DE 4128178C2. In this case, a tube is disposed in the inside of the fluid container in which a corresponding amount of fluid can enter, corresponding to the amount of fluid in the fluid container. Furthermore, a magnetic float formed as a sphere is disposed in the tube, wherein the height and the magnetic field affects Hall sensors disposed at various heights on the outside of the tube. These Hall sensors are functionally connected to a calculating device that dispatches an output signal for a level indicator.

Therefore, because the sensors contact neither fluid nor other mechanical parts, these level indicators have the advantage that they can give exact measurements even during long periods of operation because they work without wear; nonetheless, they have a complicated construction and are thereby cost intensive. While the fluid level indicator device of latter publication DE 4128178C2 requires particularly high cost because of the high number of necessary sensors, the other devices create particular problems in the assembly of the lever arms. The main disadvantage of all these inventions resides in the fact that the tilt position of the tanks, as well as the change of the liquid column to the position of the float, cannot be equalized. Correspondingly, calibration of the sensors can only be possible with a completely horizontal tank.

It is an object of the present invention to design a fluid level indicator, that is, first of all, low in maintenance and simple in construction; and, second of all, that can simultaneously compensate for angular positions of the tank, particularly when driving in mountains and valleys.

The first object is solved in that the float comprises a magnet and is so oriented in a housing that it can carry out a translational movement relative to the housing.

It is advantageous to position the magnet in the float so that it does not contact the fluid. The sensor disposed at the bottom end of the housing, as well as the connecting wires that lead from the top of the housing, are integrated into the housing by coating with resin, for example. It is possible by means of placement of the sensor at the bottom end of the housing, to send out very exact values, particularly at small levels, because the magnet is disposed at very small distances from the sensor in this range, and thereby exerts great changes in field strength with small changes in distance. In order to additionally amplify the magnetic field to obtain even better values, one can provide a back closing plate on the under side of the sensor in order to amplify the magnetic flux, wherein the plate is integrated in the housing along with the sensor. The non-contact sensor used is, particularly, a Hall sensor that has freely-programmable steps available to it and is connected with an analysis unit. Furthermore, devices are oriented on the lower side of the housing in which the fluid enters in order to break or disrupt the in-flowing fluid. Therefore, the lower end of the housing can be constructed in varying ways. It is thus suitable to provide this lower end constructed with a barrier, or with numerous small openings in the bottom of the housing, in order to prevent sloshing around of the fluid in the housing. In this manner, this underside of the housing borders directly on the floor of the fluid container in order to be able to measure even small amounts of fluid. The housing comprises further contact edges that limit the float's translational movement to a specific up and down vertical movement.

What follows relates to a fluid container with such a fluid level indicator according to the present invention.

A second object of fluid level determination at angular positions of the fluid container is solved in that the upper side of the fluid container is freely rotatably connected to the housing of the level indicator by means of a ball joint, whereby a shifting position of the fluid column in the container, for example as occurs with mountain and valley driving, can be determined by the housing with the float, and whereby the position of the fluid in the container can also be determined by means of the position of the fluid level indicator.

### SUMMARY OF THE INVENTION

In accordance with the above objectives, one embodiment of the present invention, particularly for non-spherical or small fluid containers such as, for example, in a motor vehicle tank, comprises the disposition of a magnet in the upper region of the housing. This magnet swings, particularly as occurs in mountain and valley drives, along with the moving fluid column and the housing around a ball joint. By means of the movement relative to a second sensor disposed in a cover of the fluid container directly above the magnet, the magnetic field provided by the magnet impinging on this second sensor changes as a function of the angular position of the housing of the level indicator with respect to the top side of the fluid container, so that the corresponding electrical signal generated corresponds to a measure of the position of the fluid level indicator in the tank. This sensor/magnet unit can be shielded from the magnet field of the float magnet. Both sensors are provided with an analysis unit, by means of which both output signals of the sensors calculate an exact fluid amount.

In another embodiment, the second magnet is a ring magnet whose outer diameter corresponds roughly to the inner diameter of the fluid level indicator housing, and second magnet is disposed in the region of the upper side of the housing of the fluid level indicator. The poles of this magnet lie on their upper and lower side with corresponding exact polarity around their entire circumference. Furthermore, a third sensor is built into the cover of the fluid container displaced 90° to the second sensor and in equal built-in height. Both sensors communicate with the ring magnet, so that the position of the fluid level indicator housing in the fluid container can be clearly determined based on the changing magnetic field strength that impinges on the second and third sensors. With regard to the value of the first sensor, the position of the float as well as the upper surface of the fluid in the tank is determined in all three planes (i.e. 3-dimensional xyz axis). During calibration, the fluid container is impacted with fixed, predetermined fluid amounts as well as with fixed predetermined angular positions of the container to the ground in the differing planes. A particular fluid amount can then be accorded or correlated during programming to the resulting signals of the sensors. Intermediate fluid amount values can be interpolated from the empirically-determined calibration sensor signal values.

In a further embodiment in accordance with the present invention, there is provided a fluid level indicator for a fluid container of a motor vehicle comprising: (a) a housing having at least one opening through which a fluid may flow; (b) a float disposed to move in the housing; and (c) a first magnet integrated with the float, wherein the first magnet is functionally connected to a first non-contact sensor integrated into the housing, wherein the float is connected to carry out a translational motion relative to the housing when fluid flows into or out of the at least one opening.

In a still further embodiment in accordance with the present invention, the first magnet is integrated with the float so that the first magnet does not have any contact with fluid.

In yet another embodiment in accordance with the present invention, the first sensor is connected to a connection cable, and the first sensor and the connection cable are integrated in housing by spraying of synthetic resin so that the first sensor and the connection cable have no contact with fluid.

In yet another embodiment in accordance with the present invention, the first sensor is disposed in a lower region of the housing so as to minimize distance to the first magnet so as to provide exact output values when small amounts of fluid are in the fluid container.

A yet further embodiment in accordance with the present invention further comprises a back closing plate provided on the side of the sensor opposite the first magnet to amplify a magnetic field impinging on the first sensor, wherein the back closing plate is integrated along with the first sensor in the housing.

In another embodiment in accordance with the present invention, the at least one opening for inflow of fluid into the housing is disposed in the floor region of the housing near a barrier that prevents the slushing of fluid flowing in through the at least one opening.

In another embodiment in accordance with the present invention, the housing further comprises impact edges that limit upward and downward translational movement of the float.

In a further embodiment in accordance with the present invention, a lower side of the housing directly borders the floor of the fluid container.

In another embodiment in accordance with the present invention, the housing includes a ball joint socket that connects with a ball head of the fluid container so as to form a movable ball joint.

In another embodiment in accordance with the present invention, a fluid container has fastened thereto on an upper side a fluid level indicator, the fluid level indicator comprising: (a) a housing having at least one opening through which a fluid may flow; (b) a float disposed to move in the housing; and (c) a first magnet integrated with the float, wherein the first magnet is functionally connected to a first non-contact sensor integrated into the housing, wherein the float carries out a translational motion relative to the housing when fluid flows into or out of the at least one opening.

In a still further embodiment in accordance with the present invention, the upper side of the fluid container is freely rotatably connected to the housing of the fluid level indicator by a ball joint.

In yet another embodiment in accordance with the present invention, a second magnet is disposed in an upper region of the housing so that the second magnet is operationally connected to a second non-contact sensor disposed above the second magnet and in the upper side of the fluid container, whereby movement of the housing inside of the container causes a relative movement between the second magnet and the second sensor to take place, wherein the second magnet and the second sensor form a second sensor magnet unit that is shielded from a first sensor magnet unit, wherein the first magnet and the first sensor form the first sensor magnet unit.

In another embodiment in accordance with the present invention, the thirteenth embodiment is further characterized by a ring magnet disposed in an upper region of the housing of the fluid level indicator, wherein the ring magnet is operably connected to a second non-contact sensor and to a third non-contact sensor that are both disposed in the upper side of the fluid container so as to be displaced at 90° to one another, whereby motion of the housing inside of the container results in a relative motion between the ring magnet and each of the second sensor and the third sensor, wherein the ring magnet, the second sensor and the third sensor form a second sensor magnet unit that is shielded from a first sensor magnet unit formed by the first magnet and the first sensor.

Illustrative embodiments are represented in the drawings and are described as follows. Further objects, features and advantages of the present invention will become apparent from the Detailed Description of the Preferred Embodiments, which follows, when considered together with the attached drawings.

### BRIEF DESCRIPTION OF THE DRAWINGS

FIG. 1 shows a schematic cut away representation of a fluid container according to the present invention with fluid level indicator and two sensors; and

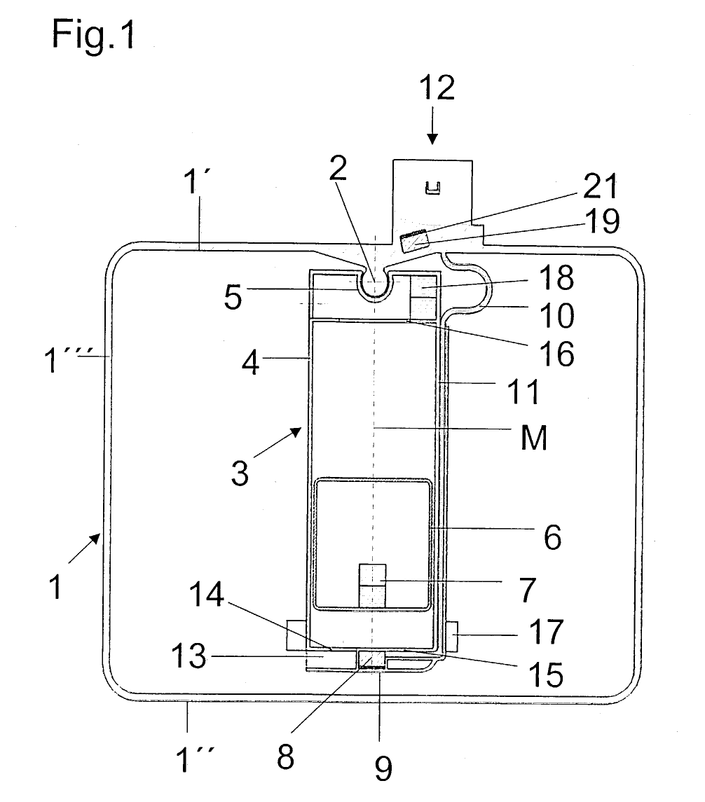

FIG. 2 shows a schematic cut out representation of a fluid container according to the present invention with a fluid level indicator and three sensors.

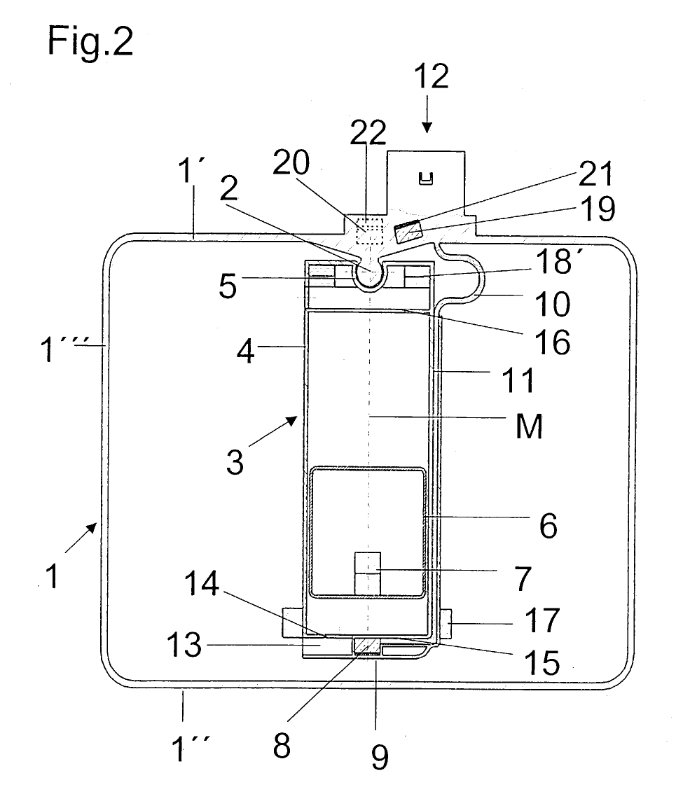

### DETAILED DESCRIPTION OF THE PREFERRED EMBODIMENTS

The invention will now be described with reference to certain illustrative non-limiting embodiments. In the drawings like parts are referred to by like reference numerals.

A depicted fluid container or tank 1 comprises an upper side 1′, a floor portion 1″, as well as one or more side portions 1′″. The ball head 2 of a ball joint (2, 5) is found on the upper side 1′ of the fluid container 1. This ball joint provides a freely-rotatable, journaled connection between the fluid container 1 and the fluid level indicator 3, whose housing 4 comprises a ball joint socket 5 connected to the ball joint head 2. A float 6 is found in the housing floor of the fluid level indicator 3, whose outer dimensions are selected so that a translational movement can be carried out in the housing 4. A magnet 7 is fixed in the float 6. This first magnet 7 is functionally connected to a first hall sensor 8 that is arranged in the lower region of the fluid level indicator housing 4. A back closing plate 9 for amplifying the magnetic field impinging on the sensor 8 is found on the side of the sensor 8 opposite the magnet 7. Sensor 8 is connected to a connection socket 12 located on the upper side 1′ of the fluid container 1 by means of a connection cable 10 that passes through a channel 11 in the housing 4, wherein the connection socket 12 provides the signals to the analysis unit (not shown).

When the fluid container 1 is filled with fluid, it streams through an inlet channel 13 into the inside of housing 4, the under end of which borders as close as possible to the underside 1b when the fluid container 1 is in the horizontal state. Inlet channel 13 is formed by one or more openings in housing 4. Slushing of fluid into the fluid level indicator 3 is prevented by a barrier 14. The float 6 floats with the magnet 7 on the fluid column, so that with rising fluid column, the distance to the sensor 8 is increased, or, as the case may be, with falling fluid column, the distance to the sensor 8 is reduced, whereby the magnetic field of magnet 7 that impinges on first sensor 8 is made smaller or larger, respectively, so that a signal from sensor 8 results that is dependent on the height of the fluid column, wherein the signal is passed on to the analysis unit over connection socket 12.

Lower impact edge 15 and upper impact edge 16 are provided in the housing 4, which delimits the translational movement of the float 6 in housing 4 in the up and down directions. The center of gravity of fluid level indicator 3 is displaced as far as possible to the bottom by means of a weight 17 disposed on the lower end of the housing, so that an optical position of the housing 4 is ensured on the fluid in the fluid container 1. By means of the suspension of fluid level indicator 3 over the ball joint (2, 5) to the fluid container 1, the forces (gravity, centrifugal force) act on the fluid level indicator 3 in the same way that they act on the fluid column in fluid container 1, so that the central axis M lies in an approximately 90° angle to the upper surface of the fluid column in the fluid container 1 at all times, even during mountain and valley driving, or when driving around curves.

In a large, particularly non-spherical container 1, it is advantageous to provide a second magnet 18 in the upper region of housing 4, which is ideally constructed as a ring magnet 18′ and communicates with a second sensor 19, or as the case may be, third sensor 20, wherein the sensors are disposed in the housing of the fluid container displaced by 90°. Preferably, sensors 19 and 20 are also Hall sensors like sensor 8. In this way, the sensors lie approximately in the same height in cover 1′ of the fluid container 1 above ring magnet 18′ when the fluid container is in the horizontal position. Each of these sensors 19 and 20 has a back lock plate 21, 22 for amplifying the magnetic field of magnet 18 (or 18′) that impinges upon them. The sensors 19 and 20, are just like sensor 8, provided with an analysis unit, so that the exact position, the angle of radial excursion and the direction of radial excursion of the fill level indicator 3 to the fluid container 1 can be calculated. This occurs, just as with sensor 8, by means of the conversion of the changing magnetic forces with the position of the magnet relative to the sensor into electrical signals.

In this manner, the analysis unit utilizes three signals, which triangulates and exactly determines the position of the float 6 in the fluid container 1 in all three planes (i.e., a three-dimensional xyz coordinate system). The measurement of each filling quantity to each measurement in liters, can be calibrated to particular float positions, or, as the case may be, fluid level indicator inclinations. With the help of reference points obtained in this manner, it is possible to, in later use, assign exact filling quantities of fluid in the container 1 even when the fluid container 1 is inclined.

The embodiment according to the present invention therefore comprises a construction that enables sending an exact indication of the filling quantity (i.e., amount of fluid in the tank 1) to the driver/operator of a motor vehicle independent of the driving situation of the motor vehicle such as occurs, for example, with mountain or valley driving that causes fluid, and the fluid column, in the tank 1 to shift relative to the horizontal axis of the vehicle.

It should be clear that the present invention is not limited to the described embodiment shapes of magnets 18, or as the case may be, the shape of housing 4, the float 6 or the freely rotatable connection of ball joint (2, 5) provided by ball joint head 2 and ball joint socket 5.

Furthermore, the present invention is particularly useful when applied to fluid containers incorporated within a motor vehicle and the term motor vehicle should be broadly interpreted to include such motorized vehicles as cars, trucks, buses, mopeds, motorcycles, three wheelers, boats, airplanes, and other like vehicles. The invention is also generally applicable to any fluid container in which it is desirable to measure the fluid level, whether in a vehicle or not.

While the present invention has been described with reference to certain preferred embodiments, one of ordinary skill in the art will recognize that additions, deletions, substitutions, modifications and improvements can be made while remaining within the spirit and scope of the present invention as defined by the appended claims.

What is claimed is:

1. A fluid level indicator for a fluid container comprising:
a housing having at least one opening through which a fluid may flow;
a float disposed to move in the housing; and
a first magnet integrated with the float, wherein the first magnet is functionally connected to a first non-contact sensor integrated into the housing, wherein the float carries out a translational motion relative to the housing when fluid flows into or out of the at least one opening.

2. A fluid level indicator according to claim 1, wherein the first magnet is integrated with the float so that the first magnet does not have any contact with fluid.

3. A fluid level indicator according to claim 1, wherein the first sensor is connected to a connection cable, and the first sensor and the connection cable are integrated in housing by spraying of synthetic resin so that the first sensor and the connection cable have no contact with fluid.

4. A fluid level indicator according to claim 1, wherein the first sensor is disposed in a lower region of the housing, so as to minimize distance to the first magnet, and so as to provide output values when small amounts of fluid are in the fluid container.

5. A fluid level indicator according to claim 1, further comprising a back closing plate provided on a side of the sensor opposite the first magnet to amplify a magnetic field impinging on the first sensor, wherein the back closing plate is integrated along with the first sensor in the housing.

6. A fluid level indicator according to claim 1, wherein the at least one opening for inflow of fluid into the housing is disposed in the floor region of the housing near a barrier disposed to prevent the slushing of fluid flowing in through the at least one opening.

7. A fluid level indicator according to claim 1, wherein the housing further comprises impact edges that limit upward and downward translational movement of the float.

8. A fluid level indicator according to claim 1, wherein a lower side of the housing directly borders the floor of the fluid container.

9. A fluid level indicator according to claim 1, wherein the housing includes a ball joint socket that connects with a ball head of the fluid container so as to form a movable ball joint.

10. A fluid container having an upper side, and having a fluid level indicator fastened to the upper side, the fluid level indicator comprising:
a housing having at least one opening through which a fluid may flow;
a float disposed to move in the housing; and
a first magnet integrated with the float, wherein the first magnet is functionally connected to a first non-contact sensor integrated into the housing, wherein the float is disposed to carry out a translational motion relative to the housing when fluid flows into or out of the at least one opening.

11. A fluid container according to claim 10, wherein the upper side of the fluid container is freely rotatably connected to the housing of the fluid level indicator by a ball joint.

12. A fluid container according to claim 11, further comprising a second magnet disposed in an upper region of the housing so that the second magnet is operationally connected to a second non-contact sensor disposed above the second magnet and in the upper side of the fluid container, whereby movement of the housing inside of the container causes a relative movement between the second magnet and the second sensor to take place, wherein the second magnet and the second sensor form a second sensor magnet unit that is shielded from a first sensor magnet unit comprising the first magnet and the first sensor.

13. A fluid container according to claim 11, further comprising a ring magnet disposed in an upper region of the housing of the fluid level indicator, wherein the ring magnet is operably connected to a second non-contact sensor and to a third non-contact sensor that are both disposed in the upper side of the fluid container so as to be displaced at 90° to one another, whereby motion of the housing inside of the container results in a relative motion between the ring magnet and each of the second sensor and the third sensor, wherein the ring magnet, the second sensor and the third sensor form a second sensor magnet unit that is shielded from a first sensor magnet unit comprising the first magnet and the first sensor.
